(19) United States
(12) Patent Application Publication
(10) Pub. No.: US 2026/0016612 A1
(43) Pub. Date: Jan. 15, 2026

(54) LIGHT BARRIER

(71) Applicant: AVANCON SA, Riazzino (CH)

(72) Inventor: Dieter SPECHT, Arcegno (CH)

(21) Appl. No.: 18/873,931

(22) PCT Filed: Jun. 30, 2022
(86) PCT No.: PCT/EP2022/068137

§ 371 Date: Dec. 11, 2024

(51) Int. Cl. G01V 8/10; G01S 7/481; G01S 7/497; G01S 17/04

(52) U.S. Cl. CPC G01V 8/10; G01S 7/4814; G01S 7/4972; G01S 17/04

(57) ABSTRACT

A light barrier, comprising a faceplate (1) with a window (10), a holder (2) that is pivotably connected to the faceplate (1) around a first axis (V), a light transmitter (3) that is arranged on the holder (2) and whose light beam can pass through the window (10), and a first adjusting means (4;40) with which the relative angular orientation between the faceplate (1) and the holder (2) is adjustable, wherein a first through hole (11) is provided in the faceplate (1), through which the first adjusting means (4;40) is accessible for adjusting.

### CROSS-REFERENCE TO RELATED APPLICATIONS

This is a U.S. national stage application of International Application No. PCT/EP2022/068137.filed Jun. 30, 2022, the contents of which are incorporated by reference.

### TECHNICAL FIELD OF THE INVENTION

The current invention relates to light barriers, in particular to built-in light barriers.

### DESCRIPTION OF THE RELATED ART

With conventional built-in light barriers, i.e., light barriers that are integrated in a housing, after their light transmitter is installed, the orientation of the light beam is checked. If it is off target, the transmitter must be removed to adjust the light beam exit angle. Thus, for the correct installation of the light transmitter, a skilled worker or several iterations are needed. This applies for through-beam light barriers and reflective light barriers. In any case, the correct orientation of such built-in light barriers is tedious.

### SUMMARY OF THE INVENTION

It is a task of current invention to provide a light barrier, whose light beam can be easily adjusted on site when it is integrated in an essentially closed housing.

This task is solved by a light barrier with the features of claim 1. Further embodiments of the light barrier and a light barrier installation are defined by the features of further claims.

A light barrier according to the invention comprises a faceplate with a window, a holder that is pivotably connected to the faceplate around a first axis, a light transmitter that is arranged on the holder and whose light beam can pass through the window, and a first adjusting means with which the relative angular orientation between the faceplate and the holder is adjustable, wherein a first through hole is provided in the faceplate, through which the first adjusting means is accessible for adjusting.

Such a design has the advantage that the orientation of the light beam of the light barrier can be adjusted on site, i.e., when it is installed in an essentially closed housing that does not provide access to the light transmitter from the side or the back for adjusting the orientation of its light beam.

The window is made from a material that is translucent for the light of the light beam. The first through hole is dimensioned as such that a tool, such as a screwdriver or a socket wrench can be inserted.

In one embodiment, the faceplate comprises a first reception on a side of the faceplate facing the holder and being aligned with the first through hole. The holder comprises a second reception being aligned with the first reception in an undeflected state. A first end of the first adjusting means is arranged in the first reception and wherein a second end of the first adjusting means is arranged in the second reception. The receptions can be separate pieces, or the first reception can be formed integrally in a single piece with the faceplate and/or the second reception can be formed integrally in a single piece with the holder. After the actuation of the first adjusting means, the holder is deflected and has an angular deviation from the initial undeflected state. It is possible to deflect the holder with respect to the faceplate in a first direction and in a second direction, opposite the first direction. The actuation of the first adjusting means can be realized by turning at least one part thereof or by pushing or pulling at least one part thereof. In one embodiment, the first adjusting means comprises a first screw and a corresponding first nut. The head of the first screw is arranged in the first reception and the first nut is arranged in the second reception. The actuation of the adjusting means can be realized by accessing the screw head with a corresponding tool. This design allows the usage of screws with any kind of screw drives. Preferably, non-external drives are used, since the dimensions of the corresponding tools are smaller. For example, screw drives that are slotted, cruciform, square, multiple-square, internal hex, pentalobular, hexalobular or a combination thereof can be used.

In one embodiment, the faceplate comprises at least one pin that is arranged in an at least one complementary third through hole of the holder, forming a pivotable connection between the faceplate and the holder. The at least one pin can be a separate piece, or it can be formed integrally in a single piece with the faceplate. It is possible to have two pins that are coaxial and whose axial distance is less than the thickness of holder around the third through hole. The end face of the at least one pin can be slanted, resulting in a pin whose height is increasing with an increasing distance from the light transmitter. The third through hole of the holder and the at least one slanted pin of the faceplate together form a snap connection.

In one embodiment, the faceplate comprises a slot on the side of the faceplate facing the holder, wherein the at least one pin protrudes in the slot at least partially, and wherein the holder is arranged in the slot with a part that comprises the at least one third through hole. With two pins, they protrude in the slot from opposite sides.

In one embodiment, the holder comprises a front part that is connected to the faceplate and a back part on which the light transmitter is arranged, and which back part is pivotably connected to the front part around a second axis. The pivotable connection between the front part and the back part acting like a hinge, can be a separate piece or can be formed integrally in a single piece with the front part and/or the back part. The holder comprises a second adjusting means with which the relative angular orientation between the front part and the back part is adjustable. A second through hole is provided in the faceplate, through which the second adjusting means is accessible for adjusting.

In one embodiment, the front part of the holder comprises a third reception being aligned with the second through hole of the faceplate in an undeflected state. The back part of the holder comprises a fourth reception being aligned with the third reception in an undeflected state. A first end of the second adjusting means is arranged in the third reception and a second end of the second adjusting means is arrange in the fourth reception. The third and fourth reception can be separate pieces, or the third reception can be formed integrally in a single piece with the front part and/or the fourth reception can be formed integrally in a single piece with the back part.

In one embodiment, the second adjusting means comprises a second screw and a corresponding second nut, wherein the head of the second screw is arranged in the third reception and wherein the second nut is arranged in the fourth reception. The second screw can be identical to the first screw, or they can have the same diameter but different lengths. The second nut can be identical to the first nut.

In one embodiment, the front part and the back part of the holder are formed integrally in a single piece and their connection comprises a material thinning forming a hinge. Alternatively, or additionally, the hinge comprises perforations.

In one embodiment, the window is formed integrally in a single piece with the rest of the face of the faceplate. Alternatively, the window can be an inserted separate piece.

In one embodiment, the first through hole is arranged in a first unclear part of the faceplate flanking the window. Additionally, or alternatively, the second through hole is arranged in a second unclear part of the faceplate flanking the window on a side opposite the first unclear part. The unclear part can be made by sandblasting or by other surface roughening processes.

In one embodiment, the faceplate comprises at least one retainer that is arranged on a lateral side of the faceplate, i.e., any one of its sides. The retainer is designed as such that when the light barrier is installed, the retainer forms a snap connection with its installation location, e.g., a housing, such as an essentially closed profile.

In one embodiment, at least one first retainer is arranged on a first lateral side of the faceplate and at least one second retainer is arranged on a second lateral side of the faceplate opposite the first lateral side. In the installed state, the retainers can be arranged top and bottom or left and right.

The window or the window together with the faceplate can be made from a transparent thermoplastic polymer, such as Polycarbonate and the holder can be made from a thermoplastic polymer, such as Polypropylene. The faceplate and/or the holder can by produced by injection moulding.

The features of the above-mentioned embodiments of the light barrier can be used in any combination, unless they contradict each other.

A light barrier installation comprising a light barrier according to one of the preceding embodiments and a light receiver or a light reflector that is arranged in an area that can be irradiated with the light beam of the light transmitter. I.e., the light beam hits the light receiver or reflector when it is switched on.

In one embodiment, the light barrier is arranged in a housing as such that the face of the faceplate of the light barrier is essentially flush with a surface of the housing, the light barrier is arranged in.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a perspective view of a light barrier according to the invention;

FIG. 2 a top view of the light barrier of FIG. 1 with a right-angled light beam orientation;

FIG. 3 a top view of the light barrier of FIG. 1 with a horizontally deflected light beam;

FIG. 4 sectional view through a vertical centre plane of the light barrier of FIG. 1; and

FIG. 5 a perspective view of the light barrier of FIG. 1 on site.

### DETAILED DESCRIPTION OF THE INVENTION

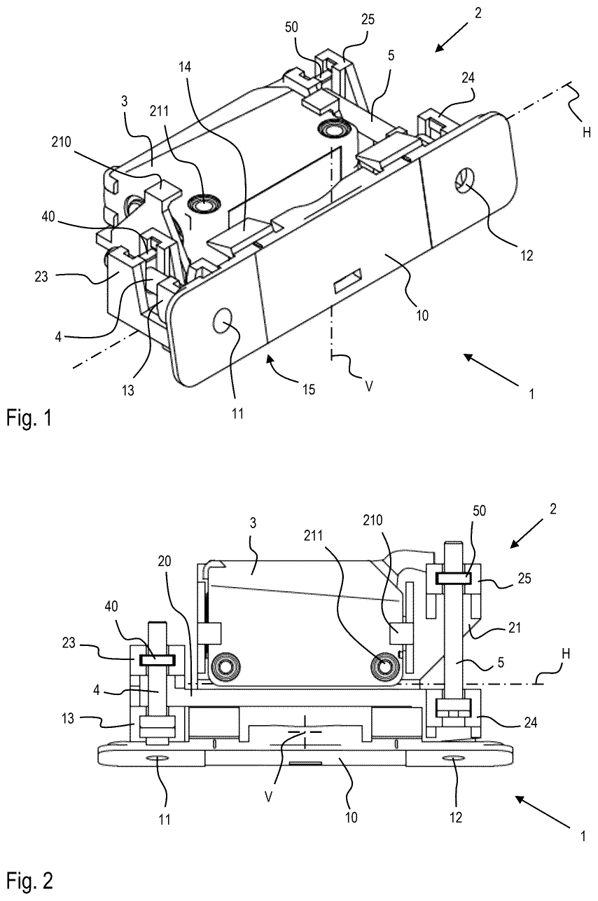

FIG. 1 shows a perspective view of a light barrier according to the invention and FIG. 2 shows a top view of the light barrier of FIG. 1 with a right-angled light beam orientation. The light barrier comprises a faceplate 1 with a window 10 that is transparent for the light beam of the installed light transmitter 3. The Window 10 is flanked by a first unclear part comprising a first through hole 11 and a second unclear part comprising a second through hole 12. Two first retainers 14 are arranged on a top lateral side of the faceplate 1 and two second retainers 15 are arranged on a bottom lateral side thereof. A holder 2 is pivotably connected to the faceplate 1 around a first axis V. The depicted first axis is a vertical axis V, allowing a pivoting of the holder 2 with respect to the faceplate 1 in a horizontal plane. The holder 2 comprises a front part 20 that is connected to the faceplate 1 and a back part 21 on which the light transmitter 3 is arranged by means of hook-shaped retainers 210 and fixation pins 211. The front part 20 and the back part 21 are plate-shaped. The back part 21 is pivotably connected to the front part 20 around a second axis H. The depicted second axis is a horizontal axis H, allowing a pivoting of the back part 21 with respect to the front part 20 in a vertical plane. The faceplate 1 comprises a first reception 13 that is aligned with the first through hole 11 and in which the head of a first adjusting screw 4 is arranged. The first reception 13 is open at its top and comprises a slot on its side opposite the faceplate 1, allowing the top insertion of the head of the first adjusting screw 4. The first reception 13 extends from the faceplate 1 towards the holder 2. The screw drive of the first adjusting screw 4 is accessible by a tool through the first through hole 11. The front part 20 of the holder 2 comprises second reception 23 that is aligned with the first reception 13 in the depicted undeflected state, and in which a first adjusting nut 40 is arranged. The front part 20 comprises a third reception 24 that is aligned with the second through hole 12 in the depicted undeflected state and in which the head of a second adjusting screw 5 is arranged. The second reception 23 and the third reception 24 extend upwards from the plate of the front part 20. The second reception 23 is open at its top and comprises a slot on its side facing the faceplate 1, allowing the top insertion of the first adjusting nut 40. The third reception 24 is open at its top and comprises a slot on its side opposite the faceplate 1, allowing the top insertion of the head of the second adjusting screw 5. The screw drive of the second adjusting screw 5 is accessible by a tool through the second through hole 12. The back part 21 of the holder 2 comprises fourth reception 25 that is aligned with the third reception 24 in the depicted undeflected state, and in which a second adjusting nut 50 is arranged. The fourth reception 25 extends upwards from the plate of the back part 21. The fourth reception 25 is open at its top and comprises a slot on its side facing the faceplate 1, allowing the top insertion of the second adjusting nut 50.

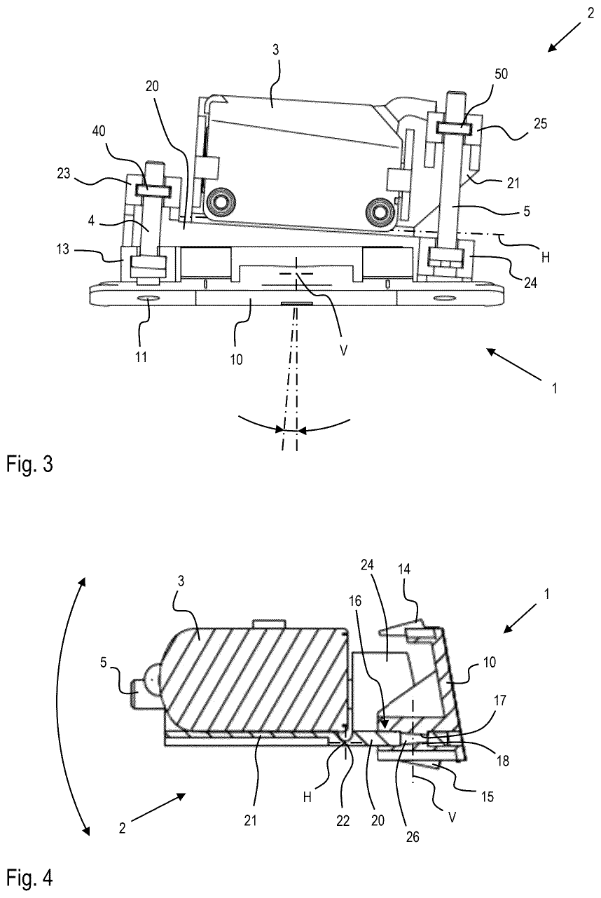

FIG. 3 shows a top view of the light barrier of FIG. 1 with a horizontally deflected light beam. To achieve such a deflection, the drive of the first adjusting screw 4 is accessed through the first through hole 11 by a tool and is rotated counterclockwise. Since the head of the first adjusting screw 4 is held in the first reception 13 of the faceplate 1, the first adjusting nut 40 is held in the second reception 23 on the front part 20 of the holder 2 and the holder 2 is pivotably connected to the faceplate 1 around a first axis V, the holder 2 is pivoted clockwise around the vertical axis V. Consequently, a clockwise rotation of the first adjusting screw 4 leads to a counterclockwise pivoting of the holder 2 around the vertical axis V.

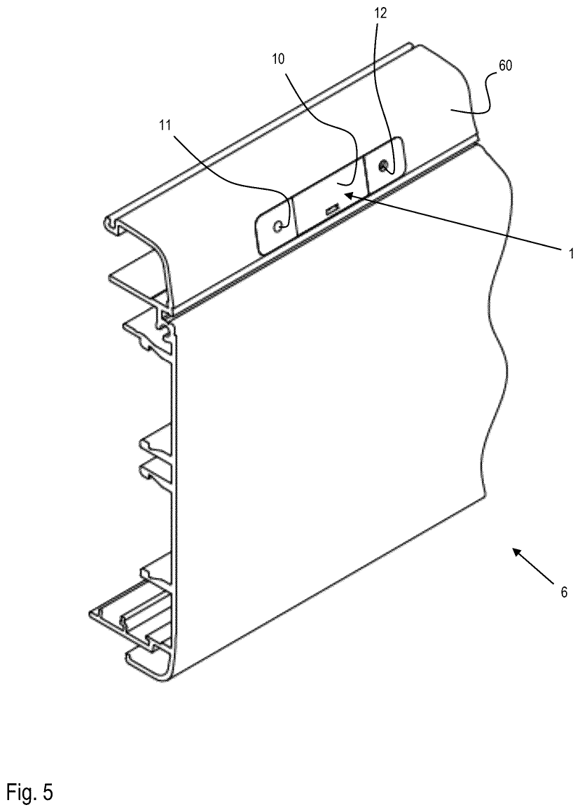

FIG. 4 shows a sectional view through a vertical centre plane of the light barrier of FIG. 1. The first retainers 14 are the components of the faceplate 1 that protrude the furthest upwards and that the second retainers 15 protrude the furthest downwards. In a lower part of the faceplate 1, i.e., in a part not irradiated by the light beam of the light transmitter 3, a horizontal slot 16 is formed, in which the front part 20 of the holder 2 is inserted. A slanted first pin 17 protrudes in the slot 16 from the top and a slanted second pin 18 coaxially from the bottom. The pins are arranged in a third through hole 26 in the front part 20 of the holder. The central axis of the pins and the third through hole are identical with the vertical axis V. The holder 2 has a plate-shaped front part 20 and a plate-shaped back part 21 that are connected to one another by a hinge 22, which is formed by a material thinning. The line of the smallest thickness of the material thinning is identical with the horizontal axis H. Since the head of the second adjusting screw 5 is held in the third reception 24 of the front part 20 of the holder 2, the second adjusting nut 50 is held in the fourth reception 25 on the back part 21 of the holder 2 and the back part 21 is pivotably connected to the front part around a second axis H, the back part 21 is pivoted downwards around the horizontal axis H by a counterclockwise rotation of the second adjusting screw 5. Consequently, a clockwise rotation of the second adjusting screw 5 leads to an upwards pivoting of the back part 21 around the horizontal axis H.

FIG. 5 shows a perspective view of the light barrier of FIG. 1 on site, i.e., built-in a housing 6. The depicted housing is a profile 6 with a surface 60 the light barrier is arranged in. The surface 60 if the profile 6 is flush with the surface of the faceplate 1. For example, such a profile can be part of a conveying system.

### REFERENCE SIGNS LIST

1 faceplate
10 window
11 first through hole
12 second through hole
13 first reception
14 first retainer
15 second retainer
16 slot
17 first pin
18 second pin
2 holder
20 front part
21 back part
210 retainer
211 pin
22 hinge
23 second reception
24 third reception
25 fourth reception
26 third through hole
3 light transmitter
4 first adjusting screw
40 first adjusting nut
5 second adjusting screw
50 second adjusting nut
6 profile
60 surface
H horizontal axis
V vertical axis

1. A light barrier, comprising a faceplate (1) with a window (10), a holder (2) that is pivotably connected to the faceplate (1) around a first axis (V), a light transmitter (3) that is arranged on the holder (2) and whose light beam can pass through the window (10), and a first adjusting means (4;40) with which the relative angular orientation between the faceplate (1) and the holder (2) is adjustable,
characterized in that a first through hole (11) is provided in the faceplate (1), through which the first adjusting means (4;40) is accessible for adjusting.

2. The light barrier according to claim 1, wherein the faceplate (1) comprises a first reception (13) on a side of the faceplate (1) facing the holder (2) and being aligned with the first through hole (11), wherein the holder (2) comprises a second reception (23) being aligned with the first reception (13) in an undeflected state, wherein a first end of the first adjusting means (4;40) is arranged in the first reception (13) and wherein a second end of the first adjusting means (4;40) is arranged in the second reception (23).

3. The light barrier according to claim 2, wherein the first adjusting means comprises a first screw (4) and a corresponding first nut (40), wherein the head of the first screw (4) is arranged in the first reception (13) and wherein the first nut (40) is arranged in the second reception (23).

4. The light barrier according to claim 1, wherein the faceplate (1) comprises at least one pin (17;18) that is arranged in an at least one complementary third through hole (26) of the holder (2), forming a pivotable connection between the faceplate (1) and the holder (2).

5. The light barrier according to claim 4, wherein the faceplate (1) comprises a slot (16) on the side of the faceplate (1) facing the holder (2), wherein the at least one pin (17;18) protrudes in the slot (16) at least partially, and wherein the holder (2) is arranged in the slot (16) with a part that comprises the at least one third through hole (26).

6. The light barrier according to claim 1, wherein the holder (2) comprising a front part (20) that is connected to the faceplate (1) and a back part (21) on which the light transmitter (3) is arranged and which back part (21) is pivotably connected to the front part (20) around a second axis (H), wherein the holder (2) comprising a second adjusting means (5;50) with which the relative angular orientation between the front part (20) and the back part (21) is adjustable, and wherein a second through hole (12) is provided in the faceplate (1), through which the second adjusting means (5;50) is accessible for adjusting.

7. The light barrier according to claim 6, wherein the front part (20) of the holder (2) comprises a third reception (24) being aligned with the second through hole (12) of the faceplate (1) in an undeflected state, wherein the back part (21) of the holder (2) comprises a fourth reception (25) being aligned with the third reception (24) in an undeflected state, wherein a first end of the second adjusting means (5;50) is arranged in the third reception (24) and wherein a second end of the second adjusting means (5;50) is arrange in the fourth reception (25).

8. The light barrier according to claim 7, wherein the second adjusting means comprises a second screw (5) and a corresponding second nut (50), wherein the head of the second screw (5) is arranged in the third reception (24) and wherein the second nut (50) is arranged in the fourth reception (25).

9. The light barrier according to claim 6, wherein the front part (20) and the back part (21) of the holder (2) are formed integrally in a single piece and their connection comprises a material thinning forming a hinge (22).

10. The light barrier according to claim 1, wherein the window (10) is formed integrally in a single piece with the rest of the face of the faceplate (1) or the window (10) is a separate piece that is inserted in the faceplate (1).

11. The light barrier according to claim 1, wherein the first through hole (11) is arranged in a first unclear part of the faceplate (1) flanking the window (10) and/or wherein the second through hole (12) is arranged in a second unclear part of the faceplate (1) flanking the window (10) on a side opposite the first unclear part.

12. The light barrier according to claim 1, wherein the faceplate (1) comprises at least one retainer (14;15) that is arranged on a lateral side of the faceplate (1).

13. The light barrier according to claim 12, wherein at least one first retainer (14) is arranged on a first lateral side of the faceplate (1) and wherein at least one second retainer (15) is arranged on a second lateral side of the faceplate (1) opposite the first lateral side.

14. A light barrier installation comprising a light barrier according to claim 1, further comprising a light receiver or a light reflector that is arranged in an area that can be irradiated with the light beam of the light transmitter (3).

15. The light barrier installation according to claim 14, wherein the light barrier is arranged in a housing (6) as such that the face of the faceplate (1) of the light barrier is essentially flush with a surface (60) of the housing (6), the light barrier is arranged in.
